(19) United States
(12) Patent Application Publication
(10) Pub. No.: US 2016/0006682 A1
(43) Pub. Date: Jan. 7, 2016

(54) UTILIZING SOCIAL NETWORKS FOR PROBLEM SOLVING

(71) Applicant: International Business Machines Corporation, Armonk, NY (US)

(72) Inventors: Paul R. Bastide, Boxford, MA (US); Adam L. Cutler, Austin, TX (US); Richard Gorzela, Andover, MA (US); Bradley W. Hurley, Tyngsboro, MA (US)

(21) Appl. No.: 14/324,501

(22) Filed: Jul. 7, 2014

(51) Int. Cl. H04L 12/58; G06F 17/30

(52) U.S. Cl. CPC H04L 51/32; G06F 17/30861; H04L 51/16; G06Q 50/01

(57) ABSTRACT

A computing device receives information detailing a question. The computing device divides the question into at least a first question segment and a second question segment. The computing device transmits the first question segment and second question segment to at least one social network contact, wherein the at least one social network contact is selected based on expertise of the at least one social network contact. The computing device receives a first response corresponding to the first question segment and a second response corresponding to the second question segment.

### FIELD OF THE INVENTION

The present invention relates generally to social media networks, and more particularly to using social media networks for problem solving.

### BACKGROUND

Social media is a form of communication that is steadily becoming a prevalent force in our everyday lives. People seek opinions, voice opinions, make connections, and ask questions using social media. Feedback via social networking helps people with answers they seek, or affirmation that their beliefs and or views are of the correct opinion of the majority. Seeking answers and advice are just a few things those who use social media are looking for.

### SUMMARY

In one aspect, the present invention provides a method for utilizing social networks for answering one or more questions. A computing device receives information detailing a question. The computing device divides the question into at least a first question segment and a second question segment. The computing device transmits the first question segment and second question segment to at least one social network contact, wherein the at least one social network contact is selected based on expertise of the at least one social network contact. The computing device receives a first response corresponding to the first question segment and a second response corresponding to the second question segment.

In another aspect, the present invention provides a computer program product for utilizing social networks for answering one or more questions, comprising program instructions to receive information detailing a question; divide the question into at least a first question segment and a second question segment; transmit the first question segment and second question segment to at least one social network contact, wherein the at least one social network contact is selected based on expertise of the at least one social network contact; and receive a first response corresponding to the first question segment and a second response corresponding to the second question segment.

In another aspect, the present invention provides a computer system for utilizing social networks for answering one or more questions, comprising program instructions to receive information detailing a question; divide the question into at least a first question segment and a second question segment; transmit the first question segment and second question segment to at least one social network contact, wherein the at least one social network contact is selected based on expertise of the at least one social network contact; and receive a first response corresponding to the first question segment and a second response corresponding to the second question segment.

In yet another aspect, the present invention provides a method for deploying social networks for answering one or more questions, comprising: receiving information detailing a question; dividing the question into at least a first question segment and a second question segment; transmitting the first question segment and second question segment to at least one social network contact, wherein the at least one social network contact is selected based on expertise of the at least one social network contact; and receiving a first response corresponding to the first question segment and a second response corresponding to the second question segment.

### BRIEF DESCRIPTION OF THE SEVERAL VIEWS OF THE DRAWINGS

FIG. 1 is a functional block diagram illustrating a problem solving system, in accordance with an embodiment of the present invention.

FIGS. 2 and 3 are a flowchart depicting the operational steps of the problem solving program of FIG. 1 in dispersing and receiving question solutions from multiple users via a social media server, in accordance with an embodiment of the present invention.

FIG. 4 is a block diagram depicting the hardware components of the problem solving program of FIG. 1, in accordance with an embodiment of the invention.

### DETAILED DESCRIPTION

Embodiments of the present invention will now be described in detail with reference to the accompanying Figures.

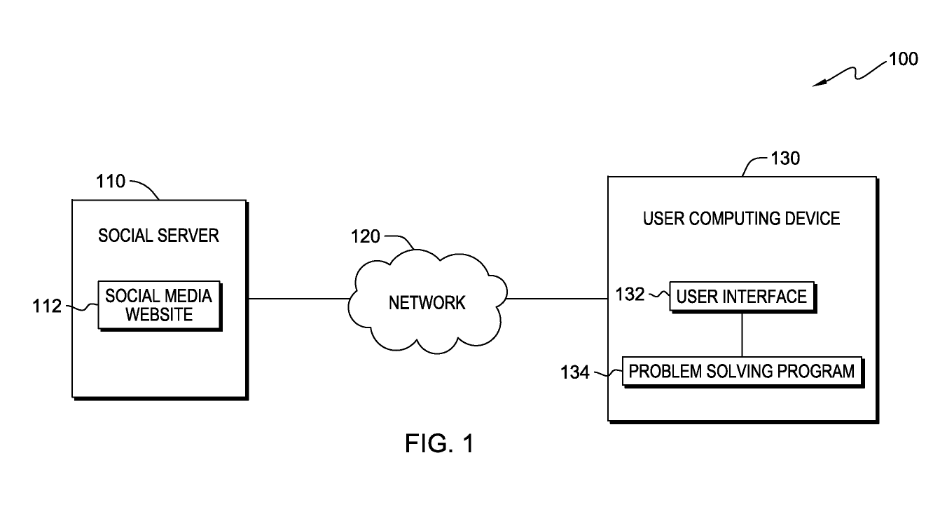

FIG. 1 illustrates problem solving system 100, in accordance with an embodiment of the present invention. In an exemplary embodiment, problem solving system 100 includes social server 110 and user computing device 130, all interconnected via network 120.

In the exemplary embodiment, network 120 is the Internet, representing a worldwide collection of networks and gateways to support communications between devices connected to the Internet. Network 120 may include, for example, wired, wireless, or fiber optic connections. In other embodiments, network 120 may be implemented as an intranet, a local area network (LAN), or a wide area network (WAN). In general, network 120 can be any combination of connections and protocols that will support communications between social server 110 and user computing device 130.

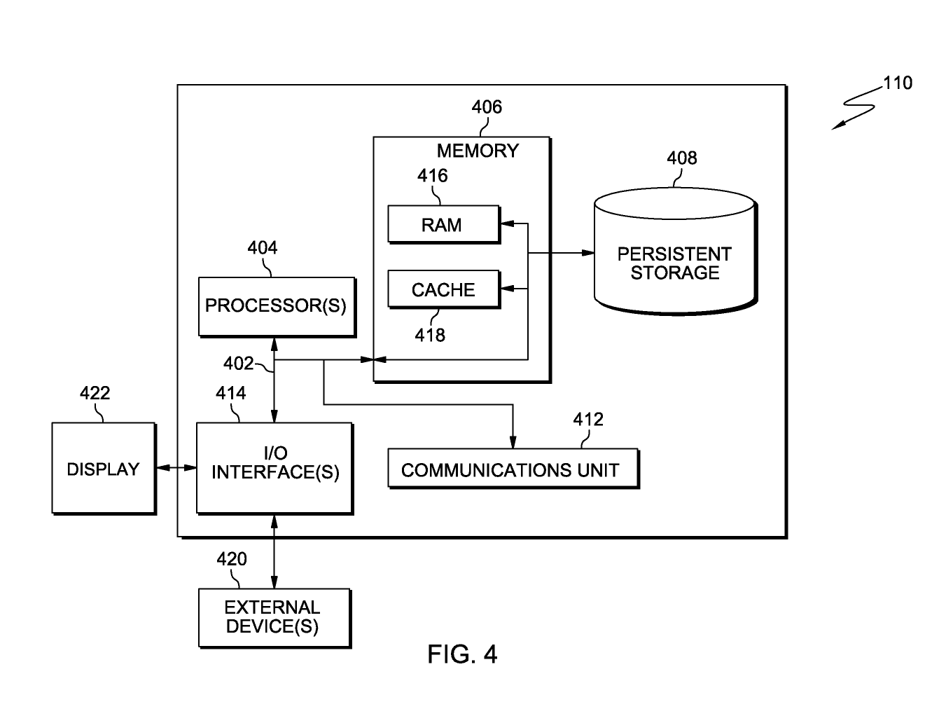

In the exemplary embodiment, social server 110 can comprise a cluster of web servers executing the same or similar software to collectively process requests for information as distributed by a front end server and a load balancer. Social server 120 may be a desktop computer, a notebook, a laptop computer, a tablet computer, a handheld device, a smart-phone, a thin client, or any other electronic device or computing system capable of receiving and sending data to and from user computing device 130 via network 120. In an exemplary embodiment, social server 110 is a computing device that is optimized for the support of websites which reside on the server, such as social media website 112, and for the support of network requests related to websites which reside on the server. Social server 120 is described in more detail with reference to FIG. 4.

In the exemplary embodiment, social server 110 includes social media website 112. Social media website 112 is a collection of files including, for example, HTML files, CSS files, image files, and JavaScript files. Social media site 112 can also include other resources, such as audio files and video files.

In the exemplary embodiment, user computing device 130 may be a laptop computer, tablet computer, notebook computer, personal computer (PC), a desktop computer, a personal digital assistant (PDA), a smart phone, or any programmable electronic device capable of communication with social server 110 via network 120. In the exemplary embodiment, user computing device 130 includes user interface 132 and problem solving program 134. User computing device 130 may include internal and external hardware components, as depicted and described in further detail with respect to FIG. 4.

In the exemplary embodiment, user interface 132 includes components used to receive input from a user of social server 110 and to transmit the received input to an application residing on user computing device 130, such as problem solving program 134. User interface 132 uses a combination of technologies, such as device drivers, to provide a platform to enable users to interact with problem solving program 134. In the exemplary embodiment, User interface 132 uses a combination of technologies, such as device drivers, to provide a platform to enable users to interact with problem solving program 134.

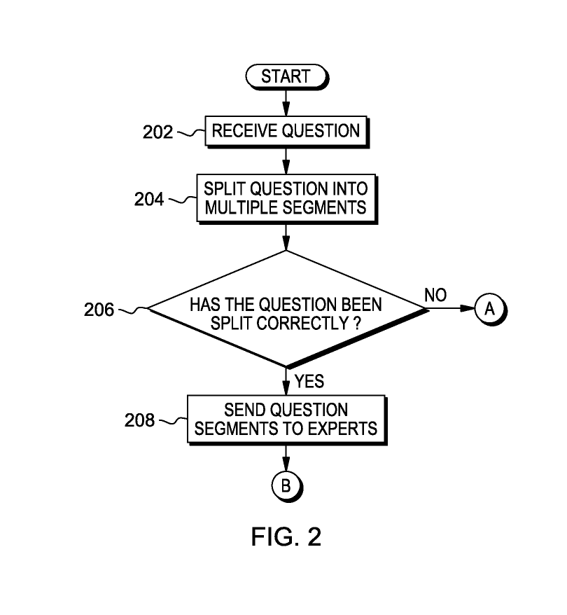

In the exemplary embodiment, problem solving program 134 is software capable of receiving data, such as data from social media website 112 via network 120. Problem solving program 134 is also capable of transmitting data to other computing devices and servers, such as social server 110 via network 120. In the exemplary embodiment, problem solving program 134 is capable of receiving information detailing a question, for example by way of user input via user interface 132, determining how to divide the question into question segments, dividing the question into question segments, and determining one or more experts for each question segment. Problem solving program 134 is discussed in further detail with regard to FIG. 2.

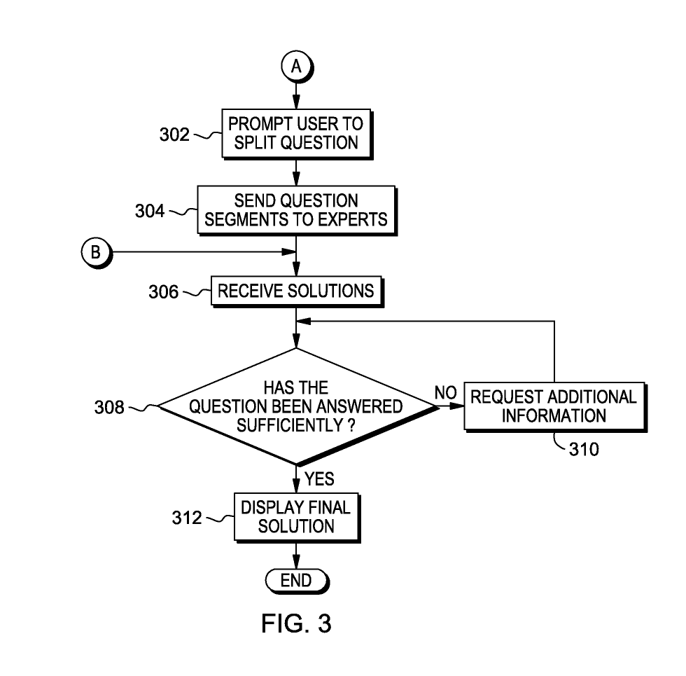

FIGS. 2 and 3 are a flowchart illustrating the operational steps of problem solving program 134 in receiving a question, determining and dividing the question into question segments, and determining one or more experts for each question segment, in accordance with an embodiment of the invention. In the exemplary embodiment, problem solving program 134 receives user input detailing a question from a user of computing device 130 via user interface 132 (step 202). For example, if the user of computing device 130 wants to purchase a new car and has a particular question pertaining to the purchase, the user may input a specific car related question into problem solving program 134. In other embodiments, problem solving program 134 may receive information detailing a question from another computing device via network 120.

Problem solving program 134 then splits the question into multiple segments (step 204). For example, if problem solving program 134 receives a question from the user of computing device 130, such as, “What color and type of car should I buy?”, then problem solving program 134 may utilize natural language techniques to split the question into two segments, such as: “Which type of car should I buy?” and “What color car should I buy?” In other embodiments, the user may manually break down the question into multiple segments based on personal preference.

Problem solving program 134 then determines if the question was split correctly (decision 206). In the exemplary embodiment, after splitting the question into multiple segments, problem solving program 134 prompts the user to verify that the question segments have been split correctly before sending the segments out to experts. Referring to the example above, problem solving program 134 prompts the user of computing device 130, via user interface 132, whether the two question segments, “Which type of car should I buy?” and “What color car should I buy?”, accurately describe the overall question the user would like more information about.

If the question segments are not split accurately (decision 206, “NO” branch), then problem solving program 134 prompts the user of computing device 130 to manually split the question into the desired question segments (step 302). For example, if problem solving program 134 splits the question “What color and type of car should I buy?” into the segments, “What color car should I buy?” and “What type of car should I buy?”, and the user of computing device 130 determines that the question segments are not split accurately, then the user of computing device 130 may manually split the question into segments such as “What color car should I buy?” and “What type of car should I buy?”.

If the question segments are split accurately (decision 206, “YES” branch), then problem solving program 134 transmits the question segments to one or more experts (step 208). If the user has split the question, as described in step 302, problem solving program 134 sends the question segments to one or more experts, as described in step 304. In the exemplary embodiment, experts may be determined based on previously answered questions and a satisfaction level or user rating associated with the answers. For example, if a social media user has a satisfaction level of 90% for car color related questions, problem solving program 134 may designate the social media user as an expert with regard to car related questions and transmit the question to the designated expert. In situations where there are multiple experts for a certain subject, problem solving program 134 may choose the expert with the highest satisfaction level. In other embodiments, a different expert, or multiple experts, may be chosen by problem solving program 134. In addition, problem solving program may communicate with social media website 112 in order to determine skills associated with a social media user. Furthermore, problem solving program 134 may communicate with an employer website or job-related social media website in order to determine a social media user's skills and experience. The determined skills may also be used in determining whether the social media user is an expert with regard to a specific subject. In other embodiments, the user of computing device 130 may manually select one or more experts from a group of “suggested experts”, created by problem solving program 134.

Problem solving program 134 then receives question segment solutions from the computing device(s) used by the expert(s) (step 306). In the exemplary embodiment, the experts may collaborate or work independently to answer a question segment. For example, if expert 1 and expert 2 receive the question “What color car should I buy?”, expert 1 and expert 2 may work together and decide that the color white would be the best color car for the user to purchase. Problem solving program 134 then receives a single answer, “white”, from the two experts instead of two separate answers. In other embodiments, problem solving program 134 receives several separate answers to the question regarding the color of the car and determines a consensus opinion.

Problem solving program 134 then determines if the question has been answered to the satisfaction of the user of computing device 130 (decision 308). In the exemplary embodiment, problem solving program 134 may prompt the user of computing device 130 to verify that the question has been sufficiently answered. For example, if the user of computing device 130 receives the answers that “white” and “hybrid” are the color and type of car the user of computing device 130 should purchase, then the user of computing device 130 can choose whether or not the answers are sufficient. If problem solving program 134 determines that the question has been answered to the satisfaction of the user of computing device 130 (decision 308, “YES” branch), then problem solving program 134 displays the final solution to the user of computing device 130 (step 312). Furthermore, problem solving program 134 may add a positive rating to the satisfaction level to the expert. For example, if the user of computing device 130 inputs a 90% satisfaction level for the answer received regarding which type of car to buy, problem solving program 134 factors the 90% rating to the existing satisfaction level for the expert regarding the relevant subject matter.

If problem solving program 134 determines that response to the question does not satisfy the user of computing device 130 (decision 308, “NO” branch), then problem solving program 134 requests additional responses from one or more experts (step 310). In the exemplary embodiment, problem solving program 134 request the same expert to answer the same question again. In other embodiments, problem solving program 134 might ask a different expert or experts to provide feedback for the question. For example, problem solving program 134 may select the expert with the next best satisfaction level. In further embodiments, problem solving program 134 may prompt the user to manually select experts to answer the question again. Once the new answer is received, problem solving program 134 once again prompts the user to determine whether the question has been answered to the satisfaction of the user of computing device 130. If the question has been answered to the satisfaction of the user of computing device 130, problem solving program 134 displays the final solution (step 312).

In another embodiment, the invention provides a method that performs the process of the invention on a subscription, advertising, and/or fee basis. That is, a service provider, such as a Solution Integrator, could offer to provide functionality for utilizing social networks for answering one or more questions. In this case, the service provider can create, maintain, support, etc., a computer infrastructure, such as problem solving system 100 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for utilizing social networks for answering one or more questions. In this case, a computer infrastructure, such as problem solving system 100 (FIG. 1), can be provided, and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as problem solving system 100 (FIG. 1), from a computer readable medium; (2) adding one or more computing devices to the computer infrastructure; and (3) incorporating and/or modifying one or more existing systems of the computer infrastructure to enable the computer infrastructure to perform the processes of the invention.

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention, as defined by the accompanying claims.

FIG. 4 depicts a block diagram of respective components of social server 110 and user computing device 130 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Social server 110 and user computing device 130 include respective communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

Problem solving program 134 and user interface 132 in user computing device 130, and social media website 112 in social media server 110, are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links. The programs problem solving program 134 and user interface 132 in user computing device 130, and social media website 112 in social media server 110, may be downloaded to persistent storage 408 through communications unit 412.

I/O interface(s) 412 allows for input and output of data with other devices that may be connected to social server 110 and user computing device 130. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention, e.g., the programs problem solving program 134 and user interface 132 in user computing device 130, and social media website 112 in social media server 110, can be stored on such portable computer-readable storage media and can be loaded onto persistent storage 408 via I/O interface(s) 414. I/O interface(s) 414 can also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge devices. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or device. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for utilizing social networks for answering one or more questions, comprising the steps of:
a computing device receiving information detailing a question;
the computing device dividing the question into at least a first question segment and a second question segment;
the computing device transmitting the first question segment and second question segment to at least one social network contact, wherein the at least one social network contact is selected based on expertise of the at least one social network contact; and
the computing device receiving a first response corresponding to the first question segment and a second response corresponding to the second question segment.

2. The method of claim 1, wherein the first question segment is transmitted to a first social network contact and the second question segment is transmitted to a second social network contact.

3. The method of claim 1, further comprising the computing device determining a final response to the question based on the first response and the second response.

4. The method of claim 1, wherein the expertise of the at least one social network contact is determined based on one or more of a social network profile, and a satisfaction level.

5. The method of claim 1, wherein the question is divided into at least a first question segment and a second question segment based on user input.

6. The method of claim 1, wherein the question is divided into at least a first question segment and a second question segment based on natural language techniques.

7. The method of claim 1, further comprising:
the computing device determining that the first response is insufficient;
the computing device transmitting the first question segment to another social network contact; and
the computing device receiving a third response corresponding to the first question segment.

8. A computer program product for utilizing social networks for answering one or more questions, the computer program product comprising:
one or more computer-readable storage devices and program instructions stored on at least one of the one or more tangible storage devices, the program instructions comprising:
program instructions to receive information detailing a question;
program instructions to divide the question into at least a first question segment and a second question segment;
program instructions to transmit the first question segment and second question segment to at least one social network contact, wherein the at least one social network contact is selected based on expertise of the at least one social network contact; and
program instructions to receive a first response corresponding to the first question segment and a second response corresponding to the second question segment.

9. The computer program product of claim 8, wherein the first question segment is transmitted to a first social network contact and the second question segment is transmitted to a second social network contact.

10. The computer program product of claim 8, further comprising program instructions to determine a final response to the question based on the first response and the second response.

11. The computer program product of claim 8, wherein the expertise of the at least one social network contact is determined based on one or more of a social network profile, and a satisfaction level.

12. The computer program product of claim 8, wherein the question is divided into at least a first question segment and a second question segment based on user input.

13. The computer program product of claim 8, wherein the question is divided into at least a first question segment and a second question segment based on natural language techniques.

14. The computer program product of claim 8, further comprising:
program instructions to determine that the first response is insufficient;
program instructions to transmit the first question segment to another social network contact; and
program instructions to receive a third response corresponding to the first question segment.

15. A computer system for utilizing social networks for answering one or more questions, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive information detailing a question;
program instructions to divide the question into at least a first question segment and a second question segment;
program instructions to transmit the first question segment and second question segment to at least one social network contact, wherein the at least one social network contact is selected based on expertise of the at least one social network contact; and
program instructions to receive a first response corresponding to the first question segment and a second response corresponding to the second question segment.

16. The computer system of 15, wherein the first question segment is transmitted to a first social network contact and the second question segment is transmitted to a second social network contact.

17. The computer system of 15, further comprising program instructions to determine a final response to the question based on the first response and the second response.

18. The computer system of 15, wherein the expertise of the at least one social network contact is determined based on one or more of a social network profile, and a satisfaction level.

19. The computer system of 15, wherein the question is divided into at least a first question segment and a second question segment based on user input.

20. The computer system of 15, further comprising:
program instructions to determine that the first response is insufficient;
program instructions to transmit the first question segment to another social network contact; and
program instructions to receive a third response corresponding to the first question segment.
